(19) United States
(12) Patent Application Publication
(10) Pub. No.: US 2016/0147532 A1
(43) Pub. Date: May 26, 2016

(54) METHOD FOR HANDLING INTERRUPTS

(71) Applicants: Junghi MIN, Goyang-si (KR); Hyung-Woo RYU, Suwon-si (KR); Kwang-Hyun LA, Uiwang-si (KR)

(72) Inventors: Junghi MIN, Goyang-si (KR); Hyung-Woo RYU, Suwon-si (KR); Kwang-Hyun LA, Uiwang-si (KR)

(21) Appl. No.: 14/948,880

(22) Filed: Nov. 23, 2015

(30) Foreign Application Priority Data
Nov. 24, 2014 (KR) 10-2014-0164480

(51) Int. Cl. G06F 9/30; G06F 12/08

(52) U.S. Cl. CPC G06F 9/3005; G06F 12/0875; G06F 2212/60; G06F 2212/452

(57) ABSTRACT

Provided is a method for handling interrupts. The method includes receiving a first interrupt, and allocating the first interrupt to a first task queue of a first processing unit among a plurality of processing units, receiving a second interrupt, and allocating the second interrupt to the first task queue, handling the first interrupt allocated to the first task queue on the first processing unit, selecting a second processing unit that will handle the second interrupt among the plurality of processing units while the first interrupt is handled, and transferring the second interrupt allocated to the first task queue to a second task queue of the selected second processing unit.

### CROSS-REFERENCE TO RELATED APPLICATIONS

This application is based on and claims priority under 35 U.S.C. §119 to Korean Patent Application No. 10-2014-0164480, filed on Nov. 24, 2014 in the Korean Intellectual Property Office, the disclosure of which is incorporated herein in its entirety by reference.

### BACKGROUND

1. Field

At least some example embodiments of the inventive concepts relate to a method for handling interrupts.

2. Description of Related Art

If multiple interrupts for data input/output tasks are generated in a computing system, an operating system that operates the computing system handles the generated interrupts using various resources that constitute the computing system.

### SUMMARY

In a computing system that includes a multiprocessor or a multi-core processor, it is desirable to properly select resources in order to handle multiple interrupts rapidly and efficiently. Accordingly, there is a need for schemes to allocate the multiple interrupts to optimum or, alternatively, desired resources in consideration of the processing ability or the state of the computing system. At least one example embodiment of the inventive concepts provides a method for handling interrupts, which can select resources for efficiently handling multiple interrupts based on the processing ability or the state of a computing system.

According to at least one example embodiment of the inventive concepts, a method for handling interrupts includes receiving a first interrupt; allocating the first interrupt to a first task queue of a first processing unit among a plurality of processing units; receiving a second interrupt; allocating the second interrupt to the first task queue; handling the first interrupt allocated to the first task queue on the first processing unit; determining whether to handle the second interrupt using a second processing unit that is different from the first processing unit among the plurality of processing units, based on the number of waiting interrupts allocated in the first task queue and a frequency of occurrence of interrupts; selecting a second processing unit among the plurality of processing units; transferring the second interrupt allocated to the first task queue to a second task queue of the selected second processing unit; and handling the second interrupt among the plurality of processing units while the first interrupt is handled.

The selecting may include selecting the second processing unit based on respective states of the plurality of processing units.

The selecting the second processing unit based on the respective states may include selecting a processing unit that is in an active state as the second processing unit.

The selecting the second processing unit based on the respective states may include selecting a processing unit that has a lower utilization rate than a utilization rate of the first processing unit as the second processing unit.

The selecting may include selecting the second processing unit based on respective states of task queues of the plurality of processing units.

The selecting the second processing unit based on the states may include selecting a processing unit having a task queue having a number of allocated interrupts that is smaller than a number of interrupts allocated to the task queue of the first processing unit, as the second processing unit.

The selecting may include selecting the second processing unit based on frequencies of occurrence of interrupts with respect to the respective processing units.

The selecting the second processing unit based on the frequencies may include selecting the processing unit, a frequency of occurrence of interrupts of which is lower than a frequency of occurrence of interrupts of the first processing unit, as the second processing unit.

The selecting may include selecting the second processing unit based on respective cache states of the plurality of processing units.

The selecting the second processing unit based on the cache states may include selecting a processing unit, a frequency of occurrence of cache misses of which is less than or equal to a frequency of occurrence of cache misses of the first processing unit, as the second processing unit.

The selecting may include selecting the second processing unit while the first processing unit is in a pending state.

The handling the second interrupt may include handling the second interrupt that is transferred to the second task queue on the selected second processing unit.

The method for handling interrupts may further include selecting a third processing unit among the plurality of processing units; and transferring the second interrupt transferred to the second task queue to a third task queue of the selected third processing unit.

The method for handling interrupts may further include handling the second interrupt that is transferred to the third task queue on the selected third processing unit.

The third processing unit may include a first processor, and the third task queue may be the first task queue.

The first processing unit may include a first central processing unit (CPU) and the second processing unit includes a second CPU.

The first processing unit may include a first core and the second processing unit may include a second core.

The first core and the second core may be processor cores included in a same multi-core processor.

According to at least on example embodiment of the inventive concepts, a method for handling interrupts may include allocating a plurality of interrupts to a plurality of processing units, the allocating including allocating two or more interrupts including a first interrupt and a second interrupt to a first processing unit; and if a number of the plurality of interrupts is larger than a number of the plurality of processing units, handling the first interrupt using the first processing unit; and handling the second interrupt using a second processing unit of the plurality of processing units.

The method for handling interrupts may further include selecting the second processing unit from among the plurality of processing units while the first interrupt is handled using the first processing unit.

The selecting the second processing unit may include selecting a processing unit that has a lower utilization rate than a utilization rate of the first processing unit as the second processing unit.

The selecting the second processing unit may include selecting a processing unit having a task queue with a number of allocated interrupts smaller than a number of interrupts allocated to a task queue of the first processing unit, as the second processing unit.

The selecting the second processing unit may include selecting a processing unit, a frequency of occurrence of interrupts of which is lower than the frequency of occurrence of interrupts of the first processing unit, as the second processing unit.

The selecting the second processing unit may include selecting the processing unit, a frequency of occurrence of cache misses of which is less than or equal to a frequency of occurrence of cache misses of the first processing unit, as the second processing unit.

The method for handling interrupts may further include transferring the second interrupt to the task queue of the second processing unit while the first interrupt is handled using the first processing unit.

According to at least one example embodiment of the inventive concepts, a method for handling interrupts may include receiving a first interrupt to be inserted into a first task queue of a first processing unit among a plurality of processing units; monitoring a state of the first task queue; selecting a second processing unit among the plurality of processing units, if a number of interrupts pre-inserted into the first task queue exceeds a first threshold value; inserting the first interrupt into a second task queue of the second processing unit; and handling the first interrupt with the second processing unit.

The selecting may include selecting the second processing unit while an interrupt that is pre-inserted into the first task queue is handled using the first processing unit.

The selecting the second processing may include monitoring a state of the second task queue; and selecting, as the second processing unit, a processing unit having a task queue with a number of pre-inserted interrupts that is equal to or smaller than a second threshold value.

The first threshold value and the second threshold value may be equal to each other.

The method for handling interrupts may further include monitoring a state of the first processing unit; and selecting the second processing unit, if the first processing unit is in an inactive state.

The selecting the second processing unit may include monitoring one or more states of one or more of the plurality of processing units; and selecting, as the second processing unit, a processing unit that is in an active state.

The method for handling interrupts may further include monitoring a utilization rate of the first processing unit; and selecting the second processing unit, if the utilization rate of the first processing unit exceeds a third threshold value.

The selecting the second processing unit may include monitoring one or more utilization rates of one or more of the plurality of processing units; and selecting, as the second processing unit, a processing unit having a utilization rate that is equal to or smaller than a fourth threshold value.

The method for handling interrupts may further include monitoring the frequency of occurrence of interrupts designated and received in the first processing unit; and selecting the second processing unit, if the frequency of occurrence of interrupts designated and received in the first processing unit exceeds a fifth threshold value.

The selecting the second processing unit may include monitoring a frequency of occurrence of interrupts designated and received in the first processing unit; and selecting the second processing unit such that a frequency of occurrence of interrupts designated and received in the second processing unit is equal to or smaller than a sixth threshold value.

According to at least one example embodiment of the inventive concepts, a method for handling interrupts may include receiving a first interrupt that is designated in a first processing unit among a plurality of processing units; inserting the received first interrupt into a first task queue of the first processing unit; receiving a second interrupt that is designated in the first processing unit; determining a first handling waiting time of the second interrupt with respect to the first task queue; determining a second handling waiting time of the second interrupt with respect to a second task queue of a second processing unit from among the plurality of processing units; and inserting the second interrupt into the second task queue if the second handling waiting time is shorter than the first handling waiting time.

The first handling waiting time may be determined while the first interrupt is handled using the first processing unit, and the second handling waiting time may be determined while the first interrupt is handled using the first processing unit.

At least one of the determining of the first handling waiting time and the determining of the second handling waiting time may be based on a number of interrupts pre-inserted into the first task queue or a number of interrupts pre-inserted into the second task queue.

At least one of the determining of the first handling waiting time and the determining of the second handling waiting time may be based on a state of the first processing unit or a state of the second processing unit.

At least one of the determining of the first handling waiting time and the determining of the second handling waiting time may be based on a frequency of occurrence of interrupts with respect to the first processing unit or a frequency of occurrence of interrupts with respect to the second processing unit.

According to at least one example embodiment of the inventive concepts, a method for handling interrupts includes allocating a first interrupt to a first processing unit by adding the first interrupt to a first task queue corresponding to first processing unit; allocating a second interrupt to the first processing unit by adding the second interrupt to the first task queue; handling the first interrupt using the first processing unit; selecting a second processing unit from among a plurality of processing units; transferring the second interrupt from the first task queue to a second task queue corresponding to the second processing unit; and handling the second interrupt using the second processing unit while the first interrupt is handled using the first processing unit.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIGS. 1A and 1B are schematic diagrams explaining a computing system that performs a method for handling interrupts according to at least some example embodiments of the inventive concepts;

FIG. 2 is a schematic diagram explaining a computing system that performs a method for handling interrupts according to at least one example embodiment of the inventive concepts;

FIG. 3 is a schematic diagram explaining a method for handling interrupts according to at least one example embodiment of the inventive concepts;

FIG. 4 is a schematic diagram explaining a method for handling interrupts according to at least another example embodiment of the inventive concepts;

FIG. 5 is a schematic diagram explaining a method for handling interrupts according to still at least another example embodiment of the inventive concepts;

FIG. 6 is a schematic diagram explaining a method for handling interrupts according to still at least another example embodiment of the inventive concepts;

FIG. 7 is a schematic diagram explaining a method for handling interrupts according to still at least another example embodiment of the inventive concepts;

FIG. 8 is a schematic diagram explaining a method for handling interrupts according to still at least another example embodiment of the inventive concepts;

FIG. 9 is a schematic diagram explaining a computing system including a multiprocessor that performs a method for handling interrupts according to at least some example embodiments of the inventive concepts;

FIG. 10 is a schematic diagram explaining a computing system including a multi-core processor that performs a method for handling interrupts according to at least some example embodiments of the inventive concepts;

FIG. 11 is a flowchart explaining a method for handling interrupts according to at least one example embodiment of the inventive concepts;

FIG. 12 is a flowchart explaining a method for handling interrupts according to at least another example embodiment of the inventive concepts;

FIG. 13 is a flowchart explaining a method for handling interrupts according to still at least another example embodiment of the inventive concepts;

FIG. 14 is a flowchart explaining a method for handling interrupts according to still at least another example embodiment of the inventive concepts; and

FIGS. 15 to 17 are views of example computing systems to which a method for handling interrupts according to at least some example embodiments of the inventive concepts can be applied.

### DETAILED DESCRIPTION OF THE EMBODIMENTS

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments of the inventive concepts are described herein with reference to schematic illustrations of idealized embodiments (and intermediate structures) of the inventive concepts. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

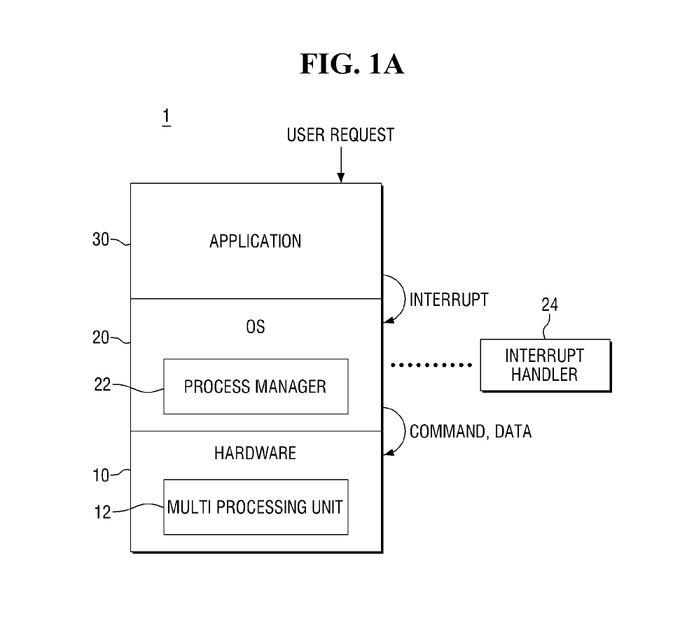

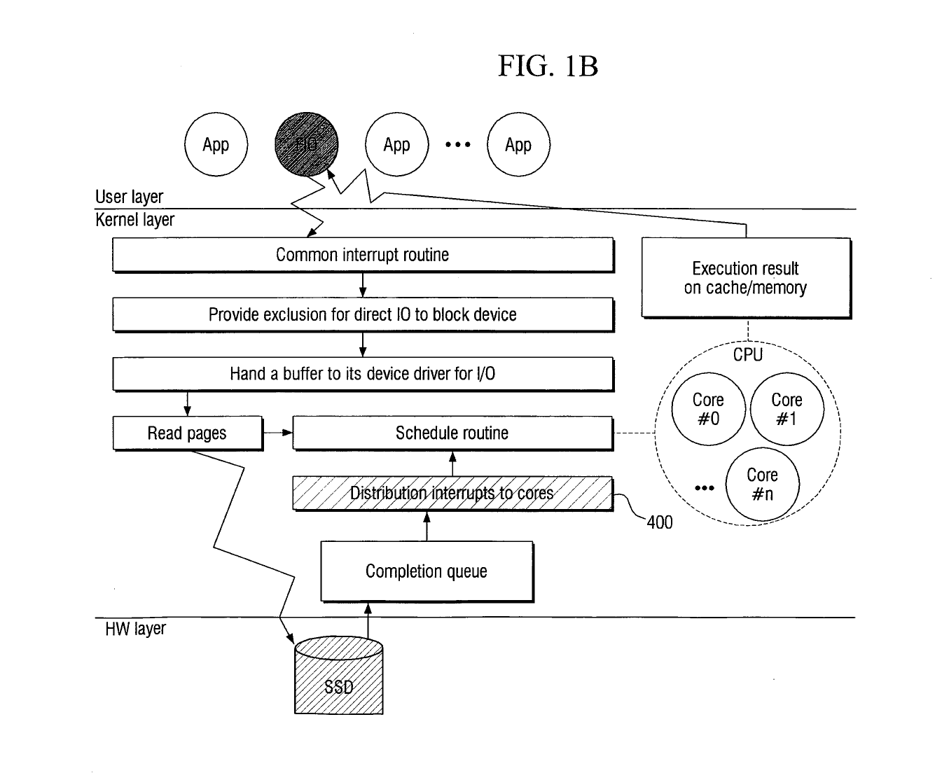

FIGS. 1A and 1B are schematic diagrams explaining a computing system that performs a method for handling interrupts according to at least some example embodiments of the inventive concepts.

Referring to FIG. 1A, a computing system 1 that performs a method for handling interrupts according to at least some example embodiments of the inventive concepts may include hardware 10, an operating system 20, and an application 30. The hardware 10 may include a processor. The term ‘processor’, as used herein, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multiprocessor, an application-specific integrated circuit (ASIC), and a field programmable gate array (FPGA).

Both the operating system 20 and the application 30 may be defined by one or more programs including instructions that are executed by one or more processors included in the hardware 10. Thus, according to at least one example embodiment of the inventive concepts, operations described herein as being performed by the operating system 20 or the application 30 may be performed by a processor executing instructions included in programs defining the operating system 20 and/or the application 30. According to at least some example embodiments of the inventive concepts, these programs may be stored, for example, in a storage device also included in the system 1.

The operating system 20 generally operates the computing system 1 through controlling the hardware 10 and supporting an execution of the application 30. For example, the operating system 20 may receive a task request from the application 30, set a series of tasks for processing the requested task, and allocate the tasks to the hardware 10. Further, the operating system 20 may transfer the result of the series of tasks that have been processed using the hardware 10 to the application 30.

In at least some example embodiments of the inventive concepts, the operating system 20 may be OSX of Apple, Inc., Windows of Microsoft Corporation, UNIX, or Linux. Further, the operating system 20 may be an operating system that is specialized for a mobile device, such as iOS of Apple, Inc. or Android of Google Inc. However, the operating system 20 is not limited to the above-described examples.

According to at least some example embodiments of the inventive concepts, the hardware 10 may include a processing unit examples of which include, but are not limited to, a CPU (Central Processing Unit), GPU (Graphic Processing Unit), AP (Application Processor), CP (Cellular Processor), or DSP (Digital Signal Processor), a memory including ROM (Read Only Memory) or RAM (Random Access Memory), a storage device including HDD (Hard Disk Drive) or SSD (Solid State Drive), and other peripheral devices, but is not limited thereto.

Particularly, in at least some example embodiments of the inventive concepts, the processing unit may be a multiprocessing unit 12. For example, the multiprocessing unit 12 may be a multiprocessor that includes multiple processors, for example, multiple CPUs. Alternatively, the multiprocessing unit 12 may be a multi-core processor that includes multiple cores.

Referring again to FIG. 1A, the application 30 may receive a user request for data input/output from a user and generate an interrupt with respect to the operating system 20. The operating system 20 may handle the interrupt that is generated by the application 30 using an interrupt handler 24. Specifically, the operating system 20 may transfer a command and data for handling the interrupt to the hardware 10 using the interrupt handler 24, and handle the interrupt using the hardware 10.

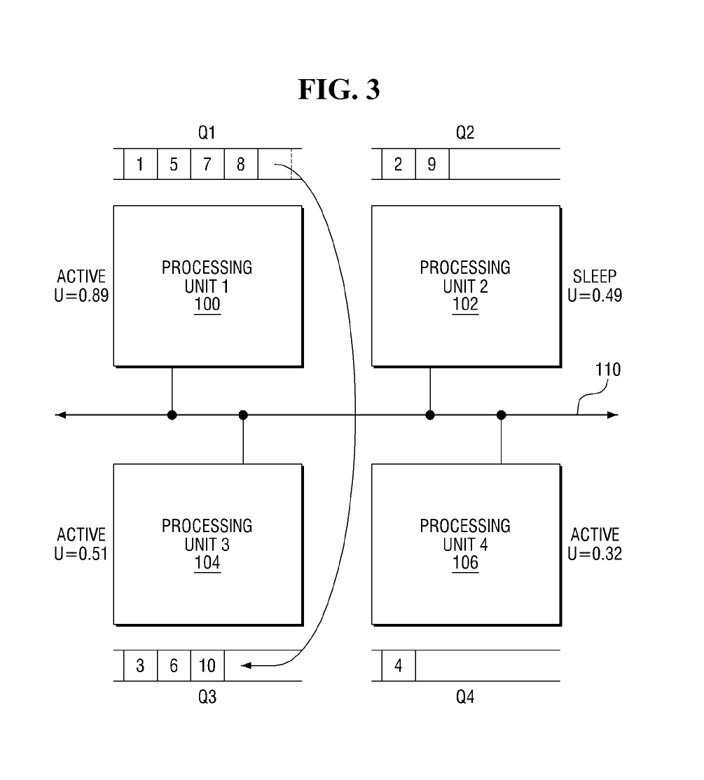

In at least some example embodiments of the inventive concepts, the interrupt may be handled using the multiprocessing unit 12 of the hardware 10. In this case, a process manager 22 in the operating system 20 may perform the method for handling interrupts according to at least some example embodiments of the inventive concepts. Specifically, the process manager 22 may properly allocate the interrupt to be handled to the multiprocessing unit 12. In at least some example embodiments of the inventive concepts, the process manager 22 may be implemented by software as a part of the operating system 20, but the detailed implementation type thereof is not limited thereto. For example, according to at least some example embodiments of the inventive concepts, the process manager may be implemented as a circuit that is included in the system 1 and is physically structured to perform the operations described herein as being performed by the process manager 22. The detailed operation of the process manager 22 will be described later with reference to FIGS. 3 to 8.

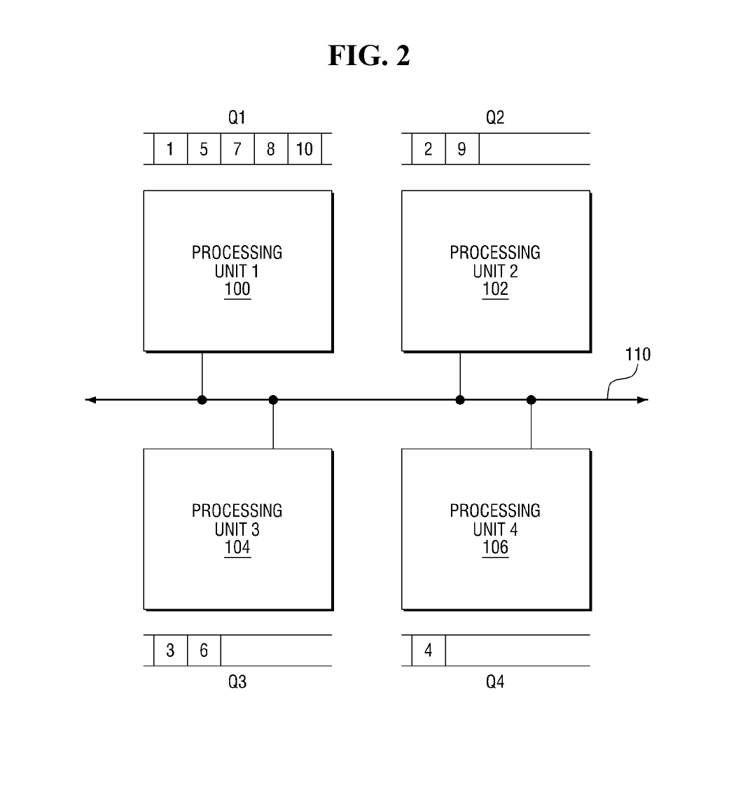

Referring FIG. 2B, user layer, kernel layer and HW layer may correspond to the application 30, the operating system 20, and the hardware 10 in FIG. 1.

The kernel layer receives the interrupts using common interrupt routines and provides exclusion for direct I/O to block device. Then, the kernel layer hands a buffer to the device driver for I/O, and read pages from the device, such as SSD (Solid State Drive). A completion queue of the kernel layer receives data or messages from the device, and transfer them to the scheduler or schedule routine to assign interrupts on the processing units (for example, cores in CPU). After that, the kernel layer obtains the execution result on the memory or the cache memory. The interrupt handling mechanisms of the present inventive concept may be performed after the kernel layer receives data in the completion queue, and before the invoking a schedule routine for handling interrupts occurred from hardware devices on the processing units.

FIG. 2 is a schematic diagram explaining a computing system that performs a method for handling interrupts according to at least one example embodiment of the inventive concepts.

Referring to FIG. 2, a computing system that performs a method for handling interrupts according to at least one example embodiment of the inventive concepts includes a plurality of processing units 100, 102, 104, and 106 and task queues Q1, Q2, Q3, and Q4 respectively provided in the plurality of processing units 100, 102, 104, and 106. The plurality of processing units 100, 102, 104, and 106 may exchange data with each other through a bus 110.

In at least some example embodiments of the inventive concepts, the first processing unit 100 may include a first CPU, and the second processing unit 102 may include a second CPU. Further, the third processing unit 104 may include a third CPU, and the fourth processing unit 106 may include a fourth CPU. That is, the plurality of processing units 100, 102, 104, and 106 may constitute one multiprocessor. Alternatively, according to at least one example embodiment of the inventive concepts, the plurality of processing units 100, 102, 104, and 106, together, may represent only a portion of a multiprocessor that includes additional CPUs.

Further, according to at least some example embodiments of the inventive concepts, instead of being CPUs, the first to fourth processing units 100-106 may be first to fourth processor cores, respectively. That is, the plurality of processing units 100, 102, 104, and 106 may be, or alternatively, be a part of, a multi-core processor.

Referring again to FIG. 2, the first processing unit 100 may be provided with a task queue Q1 for managing tasks to be performed by the first processing unit 100. The tasks to be performed by the first processing unit 100 are allocated to the first processing unit 100, and in the case where the first processing unit 100 is performing another task, a task may be inserted into the task queue Q1 in a standby state. In the case where the first processing unit 100 completes the processing of the other task, the task that is inserted into the task queue Q1 may be drawn out from the task queue Q1. Thereafter, the drawn task may be performed by the first processing unit 100. Since the second to fourth processing units 102, 104, and 106 that are provided with the task queues Q2, Q3, and Q4, respectively, perform the same operation as described above, a duplicate explanation thereof is omitted.

In at least some example embodiments of the inventive concepts, the task queues Q1, Q2, Q3, and Q4 may be managed by the operating system 20. That is, the task queues Q1, Q2, Q3, and Q4 may be generated, maintained, and deleted by the operating system 20. In at least some example embodiments of the inventive concepts, the task queues Q1, Q2, Q3, and Q4 may be implemented as priority queues, however the task queues Q1, Q2, Q3, and Q4 are not limited to being implemented as priority queues and may be implemented as other types of queues.

Referring again to FIG. 2, five tasks are inserted into the first task queue Q1 of the first processing unit 100. For example, five interrupts are allocated to the first task queue Q1 of the first processing unit 100. Further, two interrupts are allocated to the second task queue Q2, and two interrupts are allocated to the third task queue Q3 of the third processing unit 104. Further, one interrupt is allocated to the fourth task queue Q4 of the fourth processing unit 106.

Specifically, a series of detailed tasks for handling the interrupts may be allocated to the respective task queues Q1, Q2, Q3, and Q4 of the processing units 100, 102, 104, and 106. However, for convenience in explanation, as used herein, a reference to the operation of inserting or allocating of the interrupts to the task queues Q1, Q2, Q3, and Q4 of the processing units 100, 102, 104, and 106 is also a reference to the insertion or allocation of the series of detailed tasks for processing the interrupts to the task queues Q1, Q2, Q3, and Q4 of the processing units 100, 102, 104, and 106.

FIG. 3 is a schematic diagram explaining a method for handling interrupts according to at least one example embodiment of the inventive concepts.

Referring to FIG. 3, in a method for handling interrupts according to at least one example embodiment of the inventive concepts, the operating system 20 may receive the first interrupt and allocate the first interrupt to the first task queue Q1 of the first processing unit 100. Here, the first interrupt may be, for example, any one of the interrupt one 1, interrupt five 5, interrupt seven 7, and interrupt eight 8 that are pre-inserted into the first task queue Q1 as illustrated in FIG. 3. As described above with reference to FIG. 1A, the interrupts illustrated in FIG. 3 may be, for example, interrupts for performing data input/output tasks.

Next, the operating system 20 may receive the second interrupt and allocate the second interrupt to the first task queue Q1. Here, the second interrupt may be interrupt ten 10 illustrated in FIG. 3, which is an interrupt that is received by the operating system 20 after interrupt one 1, interrupt five 5, interrupt seven 7, and interrupt eight 8 that are already inserted into the first task queue Q1.

The operating system 20, specifically, the process manager 22, may select the processing unit that will handle the second interrupt among the plurality of processing units 100, 102, 104, and 106 while the first interrupt that is allocated to the first task queue Q1 is handled on the first processing unit 100. In this embodiment, the third processing unit 104 is selected as the processing unit to handle the second interrupt. Then, the process manager 22 may transfer the second interrupt that is allocated to the first task queue Q1 to the third task queue Q3 of the selected third processing unit 104, and the second interrupt that is transferred to the third task queue Q3 may be handled on the third processing unit 104. Accordingly, in the case where a large number of interrupts are already allocated to the first task queue Q1 on the first processing unit 100 and a handling waiting time of the second interrupt is considerable, the second interrupt may be transferred to another processing unit so that the second interrupt can be rapidly handled.

Referring again to FIG. 3, in this embodiment, selecting the processing unit that will handle the second interrupt among the plurality of processing units 100, 102, 104, and 106 may include selecting the processing unit that will handle the second interrupt based on the states of the respective processing units 100, 102, 104, and 106.

Selecting the processing unit that will handle the second interrupt based on the states of the respective processing units 100, 102, 104, and 106 may be performed in consideration of various elements, such as the number of interrupts that are ready to be handled by the processing units 100, 102, 104, and 106 (or length of waiting time that is consumed in the task queues Q1, Q2, Q3, and Q4), interrupt occurrence frequency, a load required to handle the interrupt for a unit time, a load by tasks allocated to the processing units 100, 102, 104, and 106, and operation states of the processing units 100, 102, 104, and 106. Such elements may be provided by the operating system 20 or the kernel.

As an example, the selecting the processing unit that will handle the second interrupt based on the states of the respective processing units 100, 102, 104, and 106 may include selecting the processing unit that is in an active state as the processing unit that will handle the second interrupt. Referring to FIG. 3, since the first processing unit 100, the third processing unit 104, and the fourth processing unit 106 are in an active state, but the second processing unit 102 is in a sleep state, the process manager 22 may select any one of the first processing unit 100, the third processing unit 104, and the fourth processing unit 106 as the processing unit that will handle the second interrupt. FIG. 3 illustrates that the third processing unit 104 is selected as the processing unit that will handle the second interrupt and is transferred to the third task queue Q3.

As another example, the selecting the processing unit that will handle the second interrupt based on the states of the respective processing units 100, 102, 104, and 106 may include selecting the processing unit that has a lower utilization rate than the utilization rate of the first processing unit 100 as the processing unit that will handle the second interrupt. Referring to FIG. 3, since the utilization rates U of the second processing unit 102, the third processing unit 104, and the fourth processing unit 106 are 0.49, 0.51, and 0.32, respectively, and thus are lower than the utilization rate U of the first processing unit 100 (i.e., 0.89), the process manager 22 may select any one of the second processing unit 102, the third processing unit 104, and the fourth processing unit 106 as the processing unit that will handle the second interrupt. When the process manager 22 takes utilization rates U into account, unlike the example illustrated in FIG. 3, the fourth processing unit 106 that has the lowest utilization rate U may be selected as the processing unit that will handle the second interrupt, and the second interrupt may be transferred to the fourth task queue Q4.

On the other hand, in at least some example embodiments of the inventive concepts, the selecting the processing unit that will handle the second interrupt among the plurality of processing units 100, 102, 104, and 106 may include selecting the processing unit that will handle the second interrupt among the plurality of processing units 100, 102, 104, and 106 while the first processing unit 100 is in a pending state. In other words, in the case where the first processing unit 100 is in an available state, the second interrupt may not be transferred to another processing unit, but may be handled by the first processing unit 100.

As described above, according to the interrupt handling methods according to various embodiments of the present invention, unlike methods for simply distributing interrupts to a plurality of processing units, for example, in a round robin, the tasks including the interrupts are distributed to optimum or, alternatively, desired, resources (e.g., processing units) in consideration of the processing ability of the computing system or the state of the hardware 10, and thus a large number of tasks can be performed efficiently and rapidly. In the case of using the former method, in a heavy interrupt situation in which the interrupt occurs at high frequency for unit time, the interrupt is continually allocated to a specific processing unit having high processing speed, and thus it is unable to avoid interrupt pending phenomenon.

In particular, according to the interrupt handling method according to various embodiments of the present invention, since the processing unit that will handle the interrupt is selected using only data (e.g., a load of threads or tasks, interrupt incoming intervals, states of the handling routines (e.g., worker in Linux kernel) of each of the processing unit, the number of the active CPUs, a load required to search a target CPU for assign interrupts for a unit time (e.g., load averages in Linux kernel) that can be provided by the operating system 20 or the kernel, it is not necessary to perform additional operation or task, such as alignment, to select the processing unit.

In addition, the interrupt handling methods according to various embodiments of the present invention may be architecture-independently performed. Specifically, the processing units 100, 102, 104, and 106 may basically follow the inherent interrupt processing method that follows, for example, ARM architecture or x86 architecture, in accordance with their kind. However, the interrupt handling methods according to various embodiments of the present invention may be implemented by a kernel code that is finally driven when the interrupt is allocated to the processing units 100, 102, 104, and 105 regardless of the kind of architecture, and thus may be performed architecture-independently. Referring to the reference number 400 in FIG. 1B, the location of the kernel code in the interrupt handling mechanism of the present inventive concept is directly before the invoking a schedule routine for handling interrupts occurred from hardware devices on the processing units. In other words, distributing (or determining) the interrupts to the processing units (or cores) are performed directly before assigning tasks associated with the interrupts to the processing units by the schedule routine. Therefore, the interrupt handling mechanism of the present inventive concept distributing the interrupts to the processing units is performed architecture-independently, like a scheduler of an OS kernel is performed architecture-independently.

Hereinafter, a method for handling interrupts according to at least some example embodiments of the inventive concepts will be described around various methods for selecting the processing unit that will handle the second interrupt.

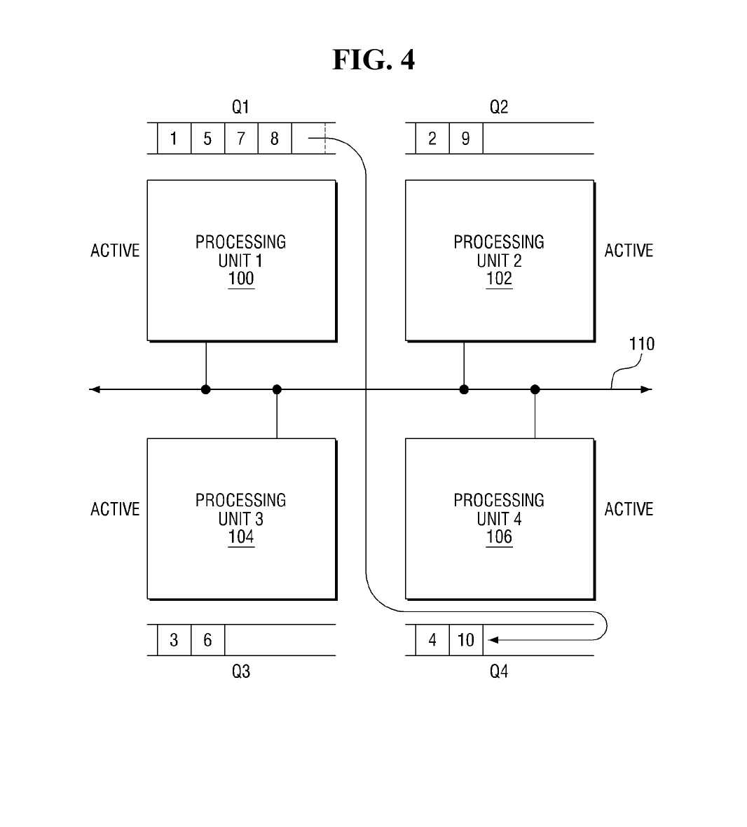

FIG. 4 is a schematic diagram explaining a method for handling interrupts according to at least another example embodiment of the inventive concepts.

Referring to FIG. 4, in a method for handling interrupts according to at least another example embodiment of the inventive concepts, the first interrupt and the second interrupt may be allocated to the first task queue Q1 of the first processing unit 100 as illustrated in FIG. 3. Thereafter, the process manager 22 may select the processing unit that will handle the second interrupt among the plurality of processing units 100, 102, 104, and 106 while the first interrupt that is allocated to the first task queue Q1 is handled.

Referring again to FIG. 4, in this embodiment, selecting the processing unit that will handle the second interrupt among the plurality of processing units 100, 102, 104, and 106 may include selecting the processing unit that will handle the second interrupt among the respective processing units 100, 102, 104, and 106 based on the states of the task queues Q1, Q2, Q3, and Q4 of the respective processing units 100, 102, 104, and 106.

As an example, the selecting the processing unit that will handle the second interrupt based on the states of the task queues Q1, Q2, Q3, and Q4 of the respective processing units 100, 102, 104, and 106 may include selecting the processing unit, the task queue of which has a number of allocated interrupts smaller than the number of interrupts allocated to the task queue of the first processing unit 100 (or, alternatively, the smallest of all the processing units 100-106), as the processing unit that will handle the second interrupt. Referring to FIG. 4, since the numbers of interrupts allocated to the respective task queues Q2, Q3, and Q4 of the second processing unit 102, the third processing unit 104, and the fourth processing unit 106 are 2, 2, and 1, respectively, and thus are smaller than the number of interrupts allocated to the task queue Q1 of the first processing unit 100 (i.e., 4), the process manager 22 may select any one of the second processing unit 102, the third processing unit 104, and the fourth processing unit 106 as the processing unit that will handle the second interrupt. FIG. 4 illustrates that the fourth processing unit 106 is selected as the processing unit that will handle the second interrupt, and the second interrupt is transferred to the fourth task queue Q4. According to at least one example embodiment of the inventive concepts, the process manager 22 may choose the processing unit having the task queue with the smallest number of allocated tasks as the recipient of the second interrupt.

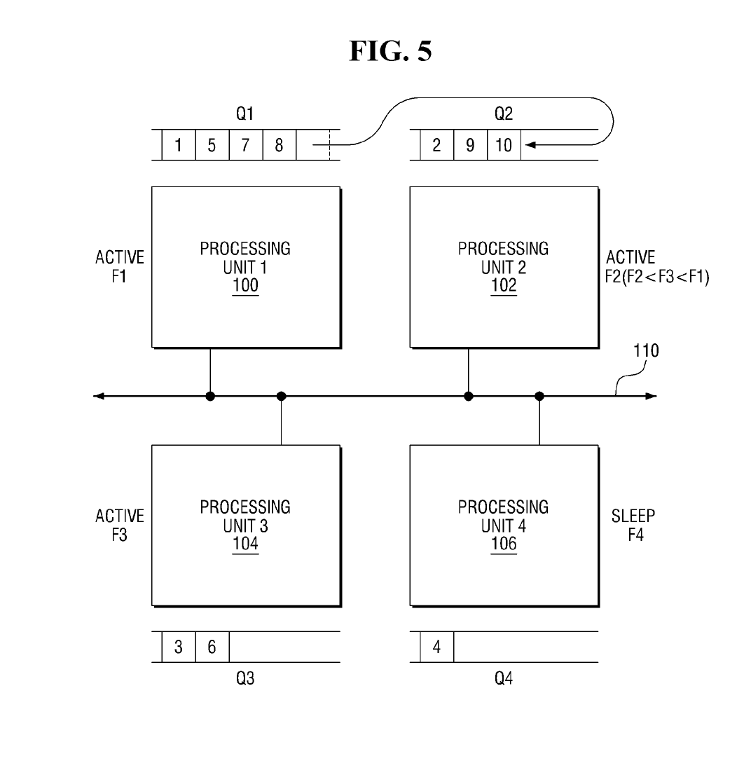

FIG. 5 is a schematic diagram explaining a method for handling interrupts according to at least another example embodiment of the inventive concepts.

Referring to FIG. 5, in a method for handling interrupts according to at least another example embodiment of the inventive concepts, the first interrupt and the second interrupt may be allocated to the first task queue Q1 of the first processing unit 100 as illustrated in FIG. 3. Thereafter, the process manager 22 may select the processing unit that will handle the second interrupt among the plurality of processing units 100, 102, 104, and 106 while the first interrupt that is allocated to the first task queue Q1 is handled.

Referring again to FIG. 5, in this embodiment, selecting the processing unit that will handle the second interrupt among the plurality of processing units 100, 102, 104, and 106 may include selecting the processing unit that will handle the second interrupt among the respective processing units 100, 102, 104, and 106 based on the frequency of occurrence of interrupts with respect to the processing units 100, 102, 104, and 106.

As an example, the selecting the processing unit that will handle the second interrupt based on the frequency of occurrence of interrupts with respect to the processing units 100, 102, 104, and 106 may include selecting the processing unit, the frequency of occurrence of interrupts of which is lower than the frequency of occurrence of interrupts of the first processing unit 100 (or, alternatively, the lowest of all the processing units 100-106), as the processing unit that will handle the second interrupt. Referring to FIG. 5, since the frequency F2 of occurrence of interrupts of the second processing unit 102 and the frequency F3 of occurrence of interrupts of the third processing unit 104 are lower than the frequency F1 of occurrence of interrupts of the first processing unit 100, the process manager 22 may select any one of the second processing unit 102 and the third processing unit 104 as the processing unit that will handle the second interrupt. FIG. 5 illustrates that the second processing unit 102 is selected as the processing unit that will handle the second interrupt, and the second interrupt is transferred to the second task queue Q2.

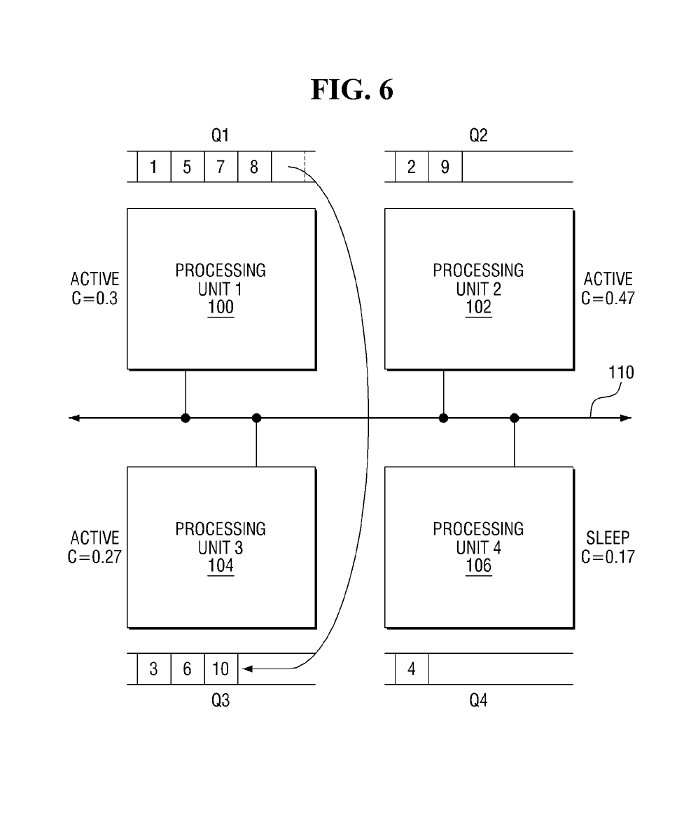

FIG. 6 is a schematic diagram explaining a method for handling interrupts according to still at least another example embodiment of the inventive concepts.

Referring to FIG. 6, in a method for handling interrupts according to still at least another example embodiment of the inventive concepts, the first interrupt and the second interrupt may be allocated to the first task queue Q1 of the first processing unit 100 as illustrated in FIG. 3. Thereafter, the process manager 22 may select the processing unit that will handle the second interrupt among the plurality of processing units 100, 102, 104, and 106 while the first interrupt that is allocated to the first task queue Q1 is handled.

Referring again to FIG. 6, in this embodiment, selecting the processing unit that will handle the second interrupt among the plurality of processing units 100, 102, 104, and 106 may include selecting the processing unit that will handle the second interrupt among the respective processing units 100, 102, 104, and 106 based on cache states of the respective processing units 100, 102, 104, and 106.

As an example, the selecting the processing unit that will handle the second interrupt based on the states of the task queues Q1, Q2, Q3, and Q4 of the processing units 100, 102, 104, and 106 may include selecting the processing unit, the frequency of occurrence of cache misses of which is equal to or less than than the frequency of occurrence of cache misses of the first processing unit 100 (or, alternatively, the lowest of all the processing units 100-106), as the processing unit that will handle the second interrupt. Referring to FIG. 6, since the frequencies C of occurrence of cache misses when the third processing unit 104 and the fourth processing unit 106 handle the second interrupt are 0.27 and 0.17, respectively, and thus are lower than the frequency C of occurrence of cache misses when the first processing unit 100 handles the second interrupt, the process manager 22 may select any one of the third processing unit 104 and the fourth processing unit 106 as the processing unit that will handle the second interrupt. FIG. 6 illustrates that the third processing unit 104 is selected as the processing unit that will handle the second interrupt, and the second interrupt is transferred to the third task queue Q3.

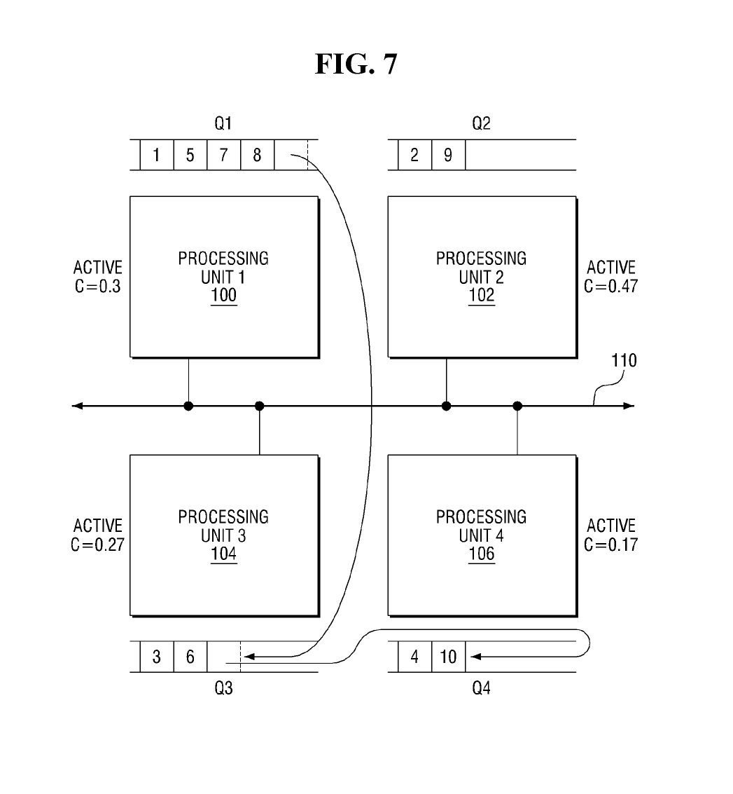

FIG. 7 is a schematic diagram explaining a method for handling interrupts according to still at least another example embodiment of the inventive concepts.

Referring to FIG. 7, this embodiment is different from the embodiment as illustrated in FIG. 6 on the point that the state of the fourth processing unit 106 has been changed from a sleep state to an active state. In the embodiment as illustrated in FIG. 6, although the frequency C of occurrence of cache misses of the fourth processing unit 106 is 0.17 that is the lowest value, the fourth processing unit 106 is in a sleep state, and thus the fourth processing unit 106 is not selected as the processing unit that will handle the second interrupt. However, in this embodiment as illustrated in FIG. 7, the state of the fourth processing unit 106 has been changed from a sleep state to an active state, and thus the fourth processing unit 106 becomes more suitable to handle the second interrupt.

In this case, in the method for handling interrupts according to still at least another example embodiment of the inventive concepts, the process manager 22 may transfer the second interrupt that has been transferred to the third task queue Q3 of the third processing unit 104 to the fourth task queue Q4 of the fourth processing unit 106 that is newly selected. Accordingly, the fourth processing unit 106 may handle the second interrupt that is transferred to the fourth task queue Q4.

On the other hand, in at least some example embodiments of the inventive concepts, the second interrupt that has been transferred to the third task queue Q3 of the third processing unit 104 may be transferred again to the first task queue Q1 of the first processing unit 100. For example, if the state of the first processing unit 100 is changed to make the first processing unit 100 become more suitable to handle the second interrupt in a state that the second interrupt has been transferred to the third task queue Q3 of the third processing unit 104, the second interrupt that has been transferred to the third task queue Q3 may be transferred again to the first task queue Q1.

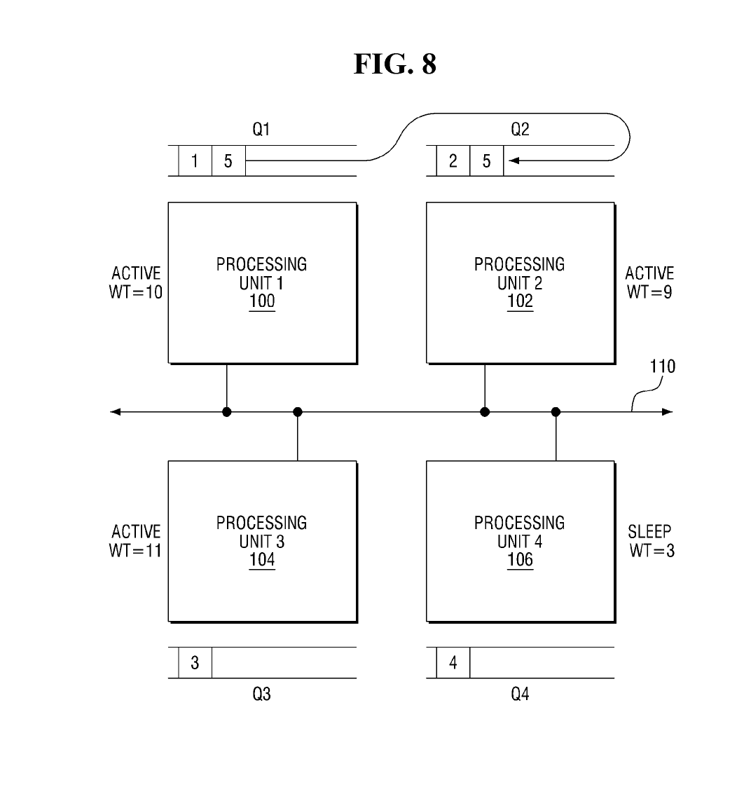

FIG. 8 is a schematic diagram explaining a method for handling interrupts according to at least another example embodiment of the inventive concepts.

Referring to FIG. 8, in a method for handling interrupts according to at least another example embodiment of the inventive concepts, the first interrupt and the second interrupt may be allocated to the first task queue Q1 of the first processing unit 100 as illustrated in FIG. 3. Thereafter, the process manager 22 may select the processing unit that will handle the second interrupt among the plurality of processing units 100, 102, 104, and 106 while the first interrupt that is allocated to the first task queue Q1 is handled.

Referring again to FIG. 8, in this embodiment, selecting the processing unit that will handle the second interrupt among the plurality of processing units 100, 102, 104, and 106 may include selecting the processing unit that will handle the second interrupt among the respective processing units 100, 102, 104, and 106 based on the handling waiting times of the second interrupt with respect to the task queues Q1, Q2, Q3, and Q4 of the respective processing units 100, 102, 104, and 106 (where the handling waiting times are amounts of time the second interrupt would wait before being handled if the second interrupt were added to task queues Q1, Q2, Q3, and Q4, respectively).

As an example, the process manager 22 may calculate the handling waiting time WT of the second interrupt in the task queues Q1, Q2, Q3, and Q4 of the respective processing units 100, 102, 104, and 106, and then may select the processing unit, the handling waiting time of the second interrupt of which is shorter than the handling waiting time of the second interrupt of the first processing unit 100 (or, alternatively, the shortest of all the processing units 100-106), as the processing unit that will handle the second interrupt. Referring to FIG. 8, since the handling waiting times of the second interrupt in the task queues Q2 and Q4 of the second processing unit 102 and the fourth processing unit 106 are 9 and 3, respectively, and thus are shorter than 10 that is the handling waiting time of the second interrupt in the task queue Q1 of the first processing unit 100, the process manager 22 may select any one of the second processing unit 102 and the fourth processing unit 106 as the processing unit that will handle the second interrupt. FIG. 8 illustrates that the second processing unit 102 is selected as the processing unit that will handle the second interrupt, and the second interrupt is transferred to the second task queue Q2.

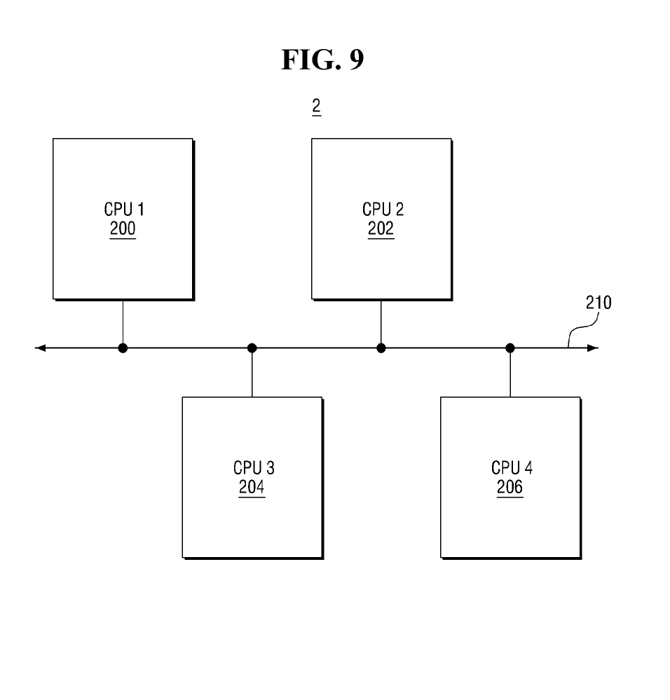

FIG. 9 is a schematic diagram explaining a computing system including a multiprocessor that performs a method for handling interrupts according to at least some example embodiments of the inventive concepts.

Referring to FIG. 9, a computing system 2 including a multiprocessor that performs a method for handling interrupts according to at least some example embodiments of the inventive concepts may include a first CPU 200, a second CPU 202, a third CPU 204, and a fourth CPU 206, which can exchange data with each other through a bus 210. Accordingly, the first to fourth CPUs 200, 202, 204, and 206 may be provided with their inherent task queues.

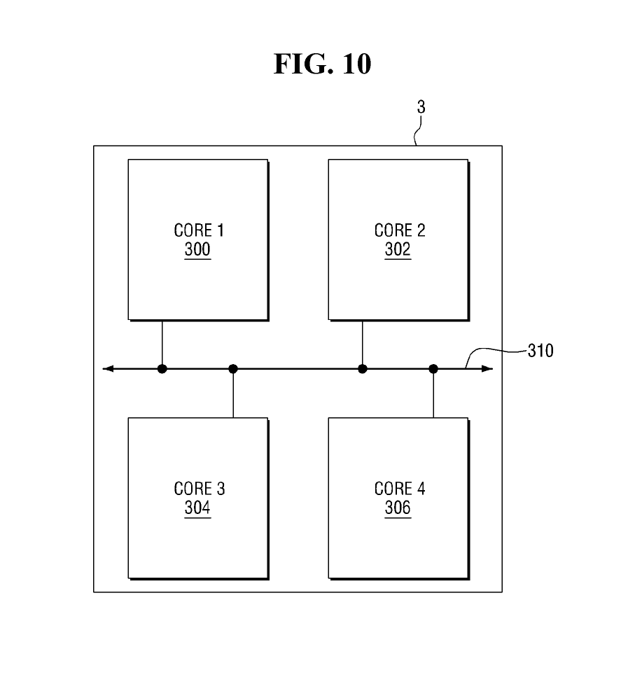

FIG. 10 is a schematic diagram explaining a computing system including a multi-core processor that performs a method for handling interrupts according to at least some example embodiments of the inventive concepts.

Referring to FIG. 10, a computing system 3 including a multi-core processor that performs a method for handling interrupts according to at least some example embodiments of the inventive concepts may include a first core 300, a second core 302, a third core 304, and a fourth core 306, which can exchange data with each other through a bus 310. Accordingly, the first to fourth cores 300, 302, 304, and 306 may be provided with their inherent task queues, respectively.

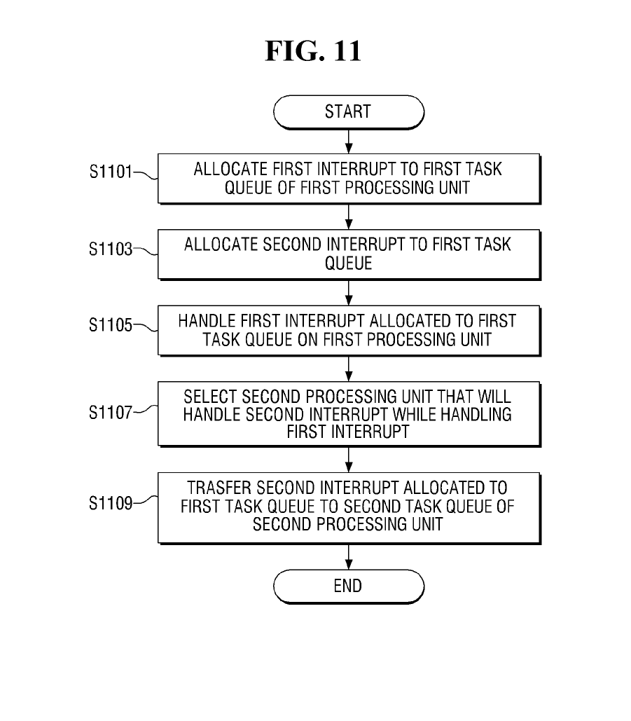

FIG. 11 is a flowchart explaining a method for handling interrupts according to at least one example embodiment of the inventive concepts.

Referring to FIG. 11, a method for handling interrupts according to at least one example embodiment of the inventive concepts may include allocating a first interrupt to a first task queue Q1 of a first processing unit 100 among a plurality of processing units 100, 102, 104, and 106 (S1101), and allocating a second interrupt to the first task queue Q1 (S1103). The method may further include handling the first interrupt that is allocated to the first task queue Q1 on the first processing unit 100 (S1105), selecting the processing unit that will handle the second interrupt among the plurality of processing units 100, 102, 104, and 106 while the first interrupt is handled (S1107), and transferring the second interrupt allocated to the first task queue Q1 to the task queue of the selected processing unit (S1109).

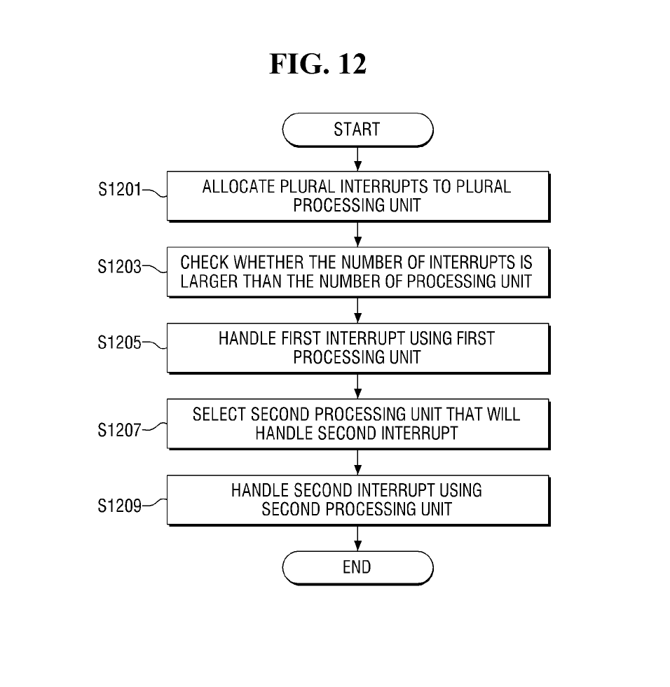

FIG. 12 is a flowchart explaining a method for handling interrupts according to at least another example embodiment of the inventive concepts.

Referring to FIG. 12, a method for handling interrupts according to at least another example embodiment of the inventive concepts may include allocating a plurality of interrupts to a plurality of processing units 100, 102, 104, and 106 (S1201), and checking whether the number of the plurality of interrupts is larger than the number of the plurality of processing units 100, 102, 104, and 106. The method may further include if the number of the plurality of interrupts is larger than the number of the plurality of processing units 100, 102, 104, and 106, handling the first interrupt using the first processing unit 100 (S1205), two or more interrupts including the first interrupt and the second interrupt being allocated to the first processing unit 100, selecting the processing unit that will handle the second interrupt among the plurality of processing units 100, 102, 104, and 106 (S1207), and handling the second interrupt using the selected processing unit (S1209).

In at least some example embodiments of the inventive concepts, the selecting the processing unit that will handle the second interrupt among the plurality of processing units 100, 102, 104, and 106 may be performed while the first interrupt is handled using the first processing unit 100. On the other hand, as described above with reference to FIGS. 3 to 8, in at least some example embodiments of the inventive concepts, the processing unit that will handle the second interrupt among the plurality of processing units 100, 102, 104, and 106 may be selected in consideration of a utilization rate of the processing unit, the number of interrupts allocated to the task queue, the frequency of occurrence of interrupts, and the frequency of occurrence of cache misses.

In at least some example embodiments of the inventive concepts, the second interrupt may be transferred to the task queue of the selected processing unit while the first interrupt is handled using the first processing unit 100.

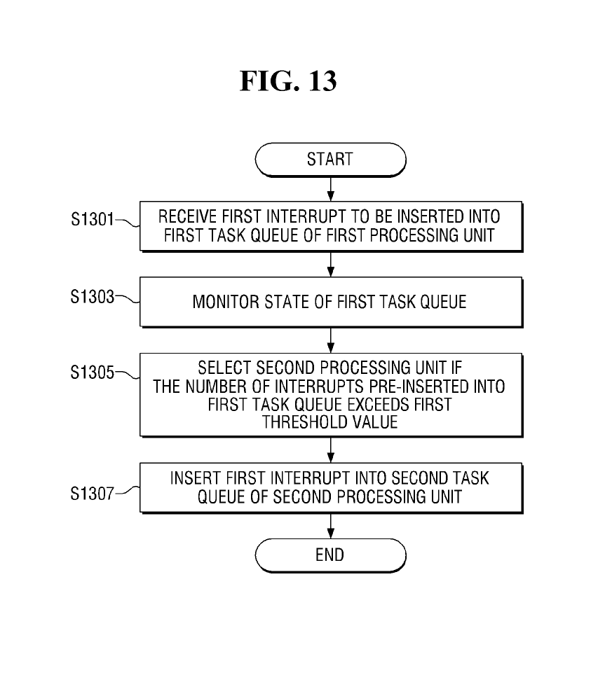

FIG. 13 is a flowchart explaining a method for handling interrupts according to at least another example embodiment of the inventive concepts.

Referring to FIG. 13, a method for handling interrupts according to still at least another example embodiment of the inventive concepts may include receiving a first interrupt to be inserted into a first task queue Q1 of a first processing unit 100 among a plurality of processing units 100, 102, 104, and 106 (S1301), monitoring a state of the first task queue Q1 (S1303), if the number of interrupts pre-inserted into the first task queue Q1 exceeds a first threshold value, selecting the processing unit that will handle the first interrupt among the plurality of processing units 100, 102, 104, and 106 (S1305), and inserting the first interrupt into the task queue of the selected processing unit (S1307). In this case, the processing unit that will handle the first interrupt may be selected among the processing units the numbers of interrupts pre-inserted into the task queues of which are equal to or smaller than a second threshold value. According to at least some example embodiments of the inventive concepts, the first threshold value and the second threshold value may be equal to each other or, alternatively, different. The first and second threshold values may each be empirically determined values.

Further, in at least some example embodiments of the inventive concepts, the selecting the processing unit that will handle the first interrupt may be performed while the interrupt that is pre-inserted into the first task queue Q1 is handled using the first processing unit 100.

On the other hand, in at least some example embodiments of the inventive concepts, the method may include monitoring the state of the first processing unit 100, and may include selecting the processing unit that will handle the first interrupt if the first processing unit 100 is in an inactive state. In this case, the processing unit that will handle the first interrupt may be selected among the processing units that are in an active state.

On the other hand, in at least some example embodiments of the inventive concepts, the method may include monitoring the utilization rate of the first processing unit 100, and may select the processing unit that will handle the first interrupt if the utilization rate of the first processing unit 100 exceeds a third threshold value. In this case, the processing unit that will handle the first interrupt may be selected among the processing units the utilization rates of which are equal to or lower than a fourth threshold value. The third and fourth threshold values may each be empirically determined values.

On the other hand, in at least some example embodiments of the inventive concepts, the method may include monitoring the frequency of occurrence of interrupts designated and received in the first processing unit 100, and may include selecting the processing unit that will handle the first interrupt if the frequency of occurrence of interrupts designated and received in the first processing unit 100 exceeds a fifth threshold value. In this case, the processing unit that will handle the first interrupt may be selected among the processing units the frequency of occurrence of interrupts designated and received of which is equal to or lower than a sixth threshold value. The fifth and sixth threshold values may each be empirically determined values.

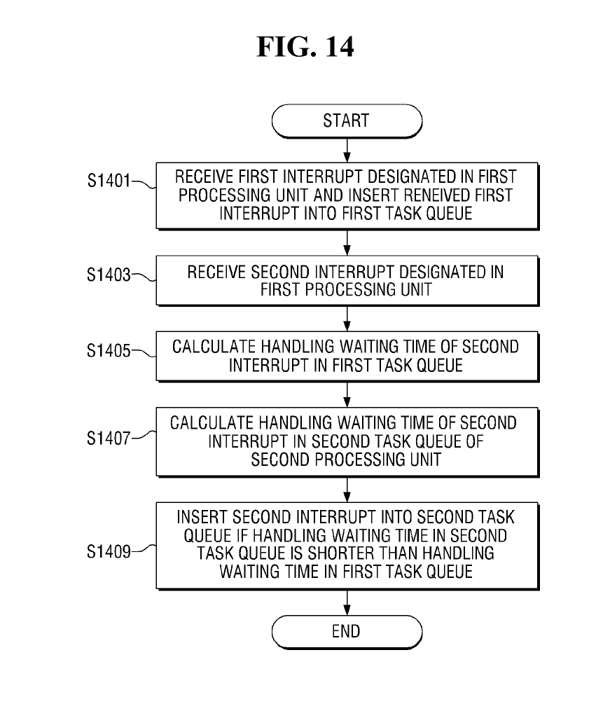

FIG. 14 is a flowchart explaining a method for handling interrupts according to still at least another example embodiment of the inventive concepts.

Referring to FIG. 14, a method for handling interrupts according to still at least another example embodiment of the inventive concepts may include receiving a first interrupt that is designated to be inserted into a first processing unit 100 among a plurality of processing units 100, 102, 104, and 106 and inserting the received first interrupt into a first task queue Q1 of the first processing unit 100 (S1401), receiving a second interrupt that is designated to be inserted into the first processing unit 100 (S1403), calculating a handling waiting time of the second interrupt in the first task queue Q1 (S1405), calculating handling waiting times of the second interrupt in task queues of other processing units among the plurality of processing units 100, 102, 104, and 106 (S1407), and inserting the second interrupt into one of the task queues of other processing units if at least one of the handling waiting times of the second interrupt in the respective task queues of the other processing units is shorter than the handling waiting time of the second interrupt in the first task queue Q1. As used herein, a task that is described as being “designated to be allocated to” or “designated in” a particular processing unit (or task queue) is a task that has been chosen, for example by a task scheduling algorithm implemented by the operating system 20 or process manager 22, to be allocated to the particular processing unit (or task queue). According to at least some example embodiments of the inventive concepts, even though a task may be designated to be allocated to a particular processor initially, the process manager may allocate the task to a different processing unit based on attributes of the plurality of processing units (e.g., processing units 100-106) in the manners discussed above with respect to at least FIGS. 2-8.

In at least some example embodiments of the inventive concepts, the calculating the handling waiting time of the second interrupt may be performed while the first interrupt is processed using the first processing unit 100. Further, in at least some example embodiments of the inventive concepts, the calculating the handling waiting time of the second interrupt may include calculating the handling waiting time of the second interrupt based on the number of interrupts pre-inserted into the respective task queues Q1, Q2, Q3, and Q4 of the plurality of processing units 100, 102, 104, and 106, states of the respective processing units 100, 102, 104, and 106, or the frequency of occurrence of interrupts with respect to the respective processing units 100, 102, 104, and 106.

According to the at least some example embodiments of the inventive concepts as described above, the tasks including the interrupts are distributed to optimum or, alternatively, desired resources (e.g., processing units) in consideration of the processing ability of the computing system or the state of the hardware 10, and thus a large number of tasks can be performed efficiently and rapidly.

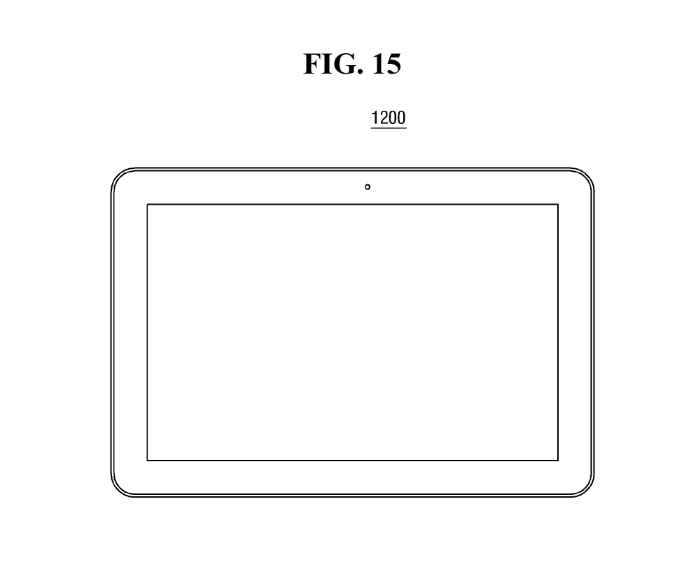

FIGS. 15 to 17 are views of example computing systems to which the method for handling interrupts according to at least some example embodiments of the inventive concepts can be applied.

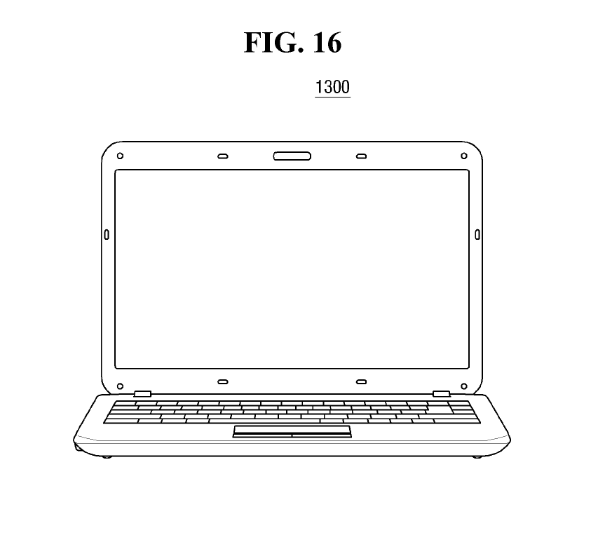

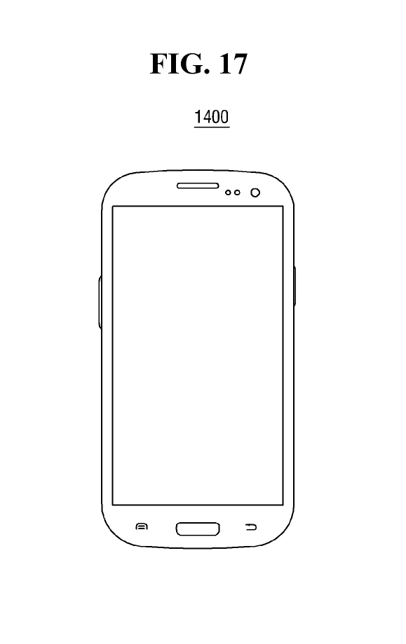

FIG. 15 illustrates a tablet PC 1200, FIG. 16 illustrates a notebook computer 1300, and FIG. 17 illustrates a smart phone 1400. The method for handling interrupts according to at least some example embodiments of the inventive concepts may be used in, for example, any of the tablet PC 1200, the notebook computer 1300, or the smart phone 1400, or, as additional examples, any multiprocessor or multi-core processor included in any device.

Further, it is apparent to those of skilled in the art that the method for handling interrupts according to at least some example embodiments of the inventive concepts can be applied even to other integrated circuits. That is, although the tablet PC 1200, the notebook computer 1300, and the smart phone 1400 have been indicated as examples of the computing system according to this embodiment, the examples of the computing system according to this embodiment are not limited thereto. In at least some example embodiments of the inventive concepts, the computing system may be implemented as a computer, UMPC (Ultra Mobile PC), workstation, net-book, PDA (Personal Digital Assistant), portable computer, wireless phone, mobile phone, e-book, PMP (Portable Multimedia Player), portable game machine, navigation device, black box, digital camera, 3D television set, digital audio recorder, digital audio player, digital picture recorder, digital picture player, digital video recorder, or digital video player.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

1. A method for handling interrupts comprising:
receiving a first interrupt;
allocating the first interrupt to a first task queue of a first processing unit among a plurality of processing units;
receiving a second interrupt;
allocating the second interrupt to the first task queue;
handling the first interrupt allocated to the first task queue on the first processing unit;
determining whether to handle the second interrupt using a second processing unit that is different from the first processing unit among the plurality of processing units, based on the number of waiting interrupts allocated in the first task queue and a frequency of occurrence of interrupts;
selecting a second processing unit among the plurality of processing units;
transferring the second interrupt allocated to the first task queue to a second task queue of the selected second processing unit; and
handling the second interrupt among the plurality of processing units while the first interrupt is handled.

2. The method for handling interrupts of claim 1, wherein the selecting includes selecting the second processing unit based on respective states of the plurality of processing units.

3. The method for handling interrupts of claim 2, wherein the selecting the second processing unit based on the respective states includes selecting a processing unit that is in an active state as the second processing unit.

4. The method for handling interrupts of claim 2, wherein the selecting the second processing unit based on the respective states includes selecting a processing unit that has a lower utilization rate than a utilization rate of the first processing unit as the second processing unit.

5. The method for handling interrupts of claim 1, wherein the selecting includes selecting the second processing unit based on respective states of task queues of the plurality of processing units.

6. (canceled)

7. The method for handling interrupts of claim 1, wherein the selecting includes selecting the second processing unit based on frequencies of occurrence of interrupts with respect to the respective processing units.

8. (canceled)

9. The method for handling interrupts of claim 1, wherein the selecting includes selecting the second processing unit based on respective cache states of the plurality of processing units.

10. The method for handling interrupts of claim 9, wherein the selecting the second processing unit based on the cache states includes selecting a processing unit, a frequency of occurrence of cache misses of which is less than or equal to a frequency of occurrence of cache misses of the first processing unit, as the second processing unit.

11. The method for handling interrupts of claim 1, wherein the selecting includes selecting the second processing unit while the first processing unit is in a pending state.

12. The method for handling interrupts of claim 1, wherein the handling the second interrupt includes handling the second interrupt that is transferred to the second task queue on the selected second processing unit.

13. The method for handling interrupts of claim 1, further comprising:
selecting a third processing unit among the plurality of processing units; and
transferring the second interrupt transferred to the second task queue to a third task queue of the selected third processing unit.

14. The method for handling interrupts of claim 13, further comprising:
handling the second interrupt that is transferred to the third task queue on the selected third processing unit.

15. (canceled)

16. The method for handling interrupts of claim 1, wherein the first processing unit includes a first central processing unit (CPU) and the second processing unit includes a second CPU.

17. The method for handling interrupts of claim 1, wherein the first processing unit includes a first core and the second processing unit includes a second core.

18. (canceled)

19. A method for handling interrupts comprising:
allocating a plurality of interrupts to a plurality of processing units, the allocating including allocating two or more interrupts including a first interrupt and a second interrupt to a first processing unit; and
if a number of the plurality of interrupts is larger than a number of the plurality of processing units,
handling the first interrupt using the first processing unit; and
handling the second interrupt using a second processing unit of the plurality of processing units.

20. The method for handling interrupts of claim 19 further comprising:
selecting the second processing unit from among the plurality of processing units while the first interrupt is handled using the first processing unit.

21. (canceled)

22. The method for handling interrupts of claim 20, wherein the selecting the second processing unit includes selecting a processing unit having a task queue with a number of allocated interrupts smaller than a number of interrupts allocated to a task queue of the first processing unit, as the second processing unit.

23. The method for handling interrupts of claim 20, wherein the selecting the second processing unit includes selecting a processing unit, a frequency of occurrence of interrupts of which is lower than the frequency of occurrence of interrupts of the first processing unit, as the second processing unit.

24. (canceled)

25. The method for handling interrupts of claim 19, further comprising:
transferring the second interrupt to the task queue of the second processing unit while the first interrupt is handled using the first processing unit.

26.-40. (canceled)

41. A method for handling interrupts comprising:
allocating a first interrupt to a first processing unit by adding the first interrupt to a first task queue corresponding to first processing unit;
allocating a second interrupt to the first processing unit by adding the second interrupt to the first task queue;
handling the first interrupt using the first processing unit;
selecting a second processing unit from among a plurality of processing units;
transferring the second interrupt from the first task queue to a second task queue corresponding to the second processing unit; and
handling the second interrupt using the second processing unit while the first interrupt is handled using the first processing unit.
